(19) United States
(12) Patent Application Publication
(10) Pub. No.: US 2024/0273269 A1
(43) Pub. Date: Aug. 15, 2024

(54) METHODS AND APPARATUS TO IMPLEMENT LOCALIZED CONTEXT CONFIGURATION FOR ELECTRONIC DESIGN AUTOMATION

(71) Applicant: Intel Corporation, Santa Clara, CA (US)

(72) Inventors: Sourav Saha, Bangalore (IN); Sagarkumar Ashokbhai Rana, Bharuch (IN)

(21) Appl. No.: 18/166,974

(22) Filed: Feb. 9, 2023

(51) Int. Cl. G06F 30/31

(52) U.S. Cl. CPC G06F 30/31; G06F 2119/06; G06F 2119/12

(57) ABSTRACT

Example systems, methods, apparatus, and articles of manufacture to implement localized context configuration for electronic design automation (EDA) are disclosed. Examples disclosed herein partition a circuit design into a plurality of contexts based on output data from a first execution iteration of an EDA tool, the output data including a netlist representative of the circuit design, the output data based on a first set of configuration parameters applied globally to the circuit design by the EDA tool. Disclosed examples also identify an outlier context in the plurality of contexts based on the output data. Disclosed examples further provide the EDA tool with a second set of configuration parameters to apply locally to the outlier context in a second execution iteration of the EDA tool, the EDA tool to apply the first set of configuration parameters to other ones of the contexts not identified as outliers.

### FIELD OF THE DISCLOSURE

This disclosure relates generally to electronic design automation and, more particularly, to implementation of localized context configuration for electronic design automation.

### BACKGROUND

Modern electronic design automation (EDA) tools employ multiple design optimization techniques to perform synthesis and placement of circuit designs, such as system-on-a-chip (SoC) designs. The design goals and/or constraints of such optimization techniques are specified by a set of configuration parameters input to the EDA tools, such as via a configuration file. Prior EDA tools then apply the set of configuration parameters globally to the circuit design when performing the synthesis and placement operations.

### BRIEF DESCRIPTION OF THE DRAWINGS

FIG. 1 is a block diagram of an example environment of use including an example EDA tool and an example localized context configuration processor implemented in accordance with teachings of this disclosure.

FIG. 2 is a block diagram of an example implementation of the localized context configuration processor of FIG. 1.

FIG. 3 illustrates an example design partitioning operation performed by the example localized context configuration processor of FIGS. 1 and/or 2.

FIG. 4 illustrates an example outlier identification operation performed by the example localized context configuration processor of FIGS. 1 and/or 2.

FIGS. 5-6 illustrate example output data from the example EDA tool of FIG. 1 to be processed by an example tool configuration operation performed by the example localized context configuration processor of FIGS. 1 and/or 2.

FIG. 7-8 are flowcharts representative of example machine readable instructions and/or example operations that may be executed by example processor circuitry to implement the example localized context configuration processor of FIGS. 1 and/or 2.

FIG. 9 is a block diagram of an example processing platform including processor circuitry structured to execute the example machine readable instructions and/or the example operations of FIGS. 7-8 to implement the example localized context configuration processor of FIGS. 1 and/or 2.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 7-8) to client devices associated with end users and/or consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Example methods, apparatus, systems and articles of manufacture (e.g., physical storage media) to implement localized context configuration for electronic design automation are disclosed herein. As noted above, EDA tools can utilize multiple design optimization techniques to perform synthesis and placement of input circuit designs, with the goals and/or constraints of the optimization techniques specified via configuration parameters input to the EDA tools, such as via a configuration file. For example, optimization techniques utilized by the EDA tools can be tailored to meet performance (e.g., timing), power and/or area goals, also referred to as PPA goals, specified via the input configuration parameters. Prior EDA tools then apply the configuration parameters globally to the entire circuit when performing the synthesis and placement of the design. However, PPA convergence can be accelerated if different sets of configuration parameters can be applied to different localized regions of the circuit design depending on the design characteristics of those different localized regions.

Example of localized context configuration, as disclosed herein, provide the ability to configure EDA tools to perform localized design optimization on identified portions of a circuit design, and global design optimization to remaining portions of the design. For example, localized context configuration, as disclosed herein, implements an end-to-end algorithmic framework to determine which regions of a partitioned circuit design are to be targeted for localized design optimization. In examples disclosed herein, circuit design characteristics output from execution of the EDA tool to perform circuit synthesis (and/or placement) are compared to one or more thresholds to identify outlier regions to be targeted for localized design optimization. For example, localized context configuration can be tailored to focus on power optimization by identifying outlier regions based on localized clock power, dynamic power, leakage power, etc. In examples disclosed herein, different local configuration parameters sets are determined for the identified outlier regions relative to a global configuration parameter set specified for the remainder of the circuit design, thereby enabling localized design optimization of the identified outlier regions. For example, considering the power optimization example described previously, node-slack characteristics output from the execution of the EDA tool can be harvested and converted into a histogram to analyze relative timing criticality for the different partitioned regions of the circuit design, and to identify one or more node-slack thresholds to be varied to bias power vs. timing optimization for the identified outlier regions.

In some examples of localized context configuration disclosed herein, example EDA tools are modified to include application programming interfaces (APIs) to support specification of multiple sets of configurations parameters and to identify whether a given configuration parameter set is to apply globally to the circuit design or locally to a specified region of the design. Additionally or alternatively, the APIs of such example modified EDA tools may enable different regions of the design to be optimized in parallel to reduce synthesis execution time when one or more criteria are met, such as when one or more logical and/or timing path and/or group criteria are met. Additionally or alternatively, the APIs of such example modified EDA tools may enable specification of a transition region between an identified outlier region and remaining regions of the circuit design to avoid abrupt discontinuities in the behavior of the synthesized circuit.

These and other example methods, apparatus, systems and articles of manufacture (e.g., physical storage media) to implement localized context configuration for electronic design automation are disclosed in further detail below.

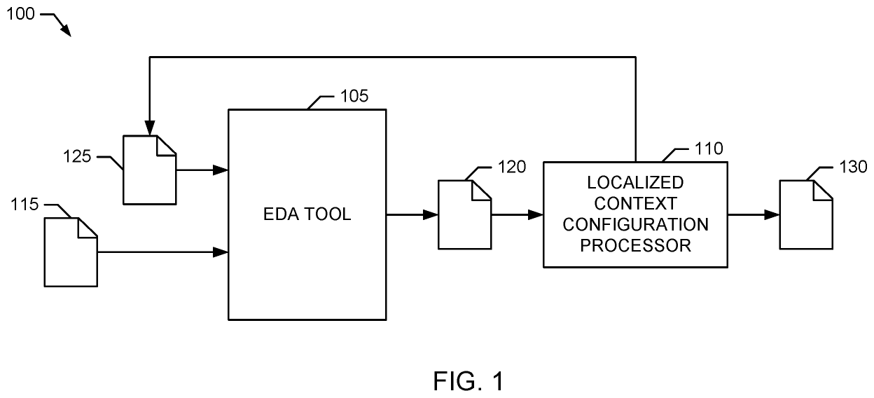

Turning to the figures, FIG. 1 is a block diagram of an example environment of use 100 that includes an example EDA tool 105 and an example localized context configuration processor 110 that implement localized context configuration for electronic design automation in accordance with teachings of this disclosure. The EDA tool 105 of the illustrated example can correspond to any EDA tool adapted as disclosed herein to interface and operate with the localized context configuration processor 110. For example, the EDA tool 105 can correspond to, but is not limited to, Fusion Compiler™ by Synopsys®, Design Compiler® by Synopsys®, RTL Architect™ by Synopsys®, Innovus™ Implementation System by Cadence® Genus™ Synthesis Solution by Cadence®, Tempus™ Timing Signoff Solution by Cadence®, etc., but adapted with APIs to accept local set(s) of configuration parameters and associated control information, as disclosed herein.

In the illustrated example of FIG. 1, the EDA tool 105 operates on an example input logical circuit design 115 to provide example output data 120 that includes an example synthesized physical design of the circuit and associated characteristics of the synthesized circuit. For example, the input logical circuit design 115 can be in the form of a register transfer level (RTL) abstraction written in a hardware description language (HDL) that provides a logical abstract of the circuit design, such as an SoC circuit design. The EDA tool 105 operates to translate the RTL input circuit design 115 into a synthesized physical design of the circuit, which is included in the output data 120. For example, the output data 120 may include an example netlist that represents the physical circuit design.

In some examples, the RTL input circuit design 115 includes several levels of logical hierarchy to support RTL coding, RTL verification, simulation and optimization, such as timing, power and/or area optimization. In some examples, the physical circuit design included in the output data 120 exhibits several levels of physical hierarchy that include logic groups (e.g., groups of logical cells and/or logical gates) at different hierarchical levels. For example, there may be 10-25 logic groups at one level down from the top level of a complex circuit design. As disclosed in further detail below, the logic groups identified in the logical and/or physical hierarchies of the circuit design can be used to identify outlier groups (or regions or, more generally, contexts) for which local configuration of EDA tool parameters and, thus, localized optimization is to be utilized.

With the foregoing in mind, during an example initial execution iteration of the EDA tool 105, the localized context configuration processor 110 configures the EDA tool 105 with an initial set of example configuration parameters 125 to be used by the EDA tool 105 to synthesize the input logical circuit design 115. For this initial execution iteration, the localized context configuration processor 110 includes a global set of configuration parameters to be applied by the EDA tool 105 globally to synthesize the circuit design and generate the output data 120 corresponding to the initial execution iteration. As disclosed in further detail below, the localized context configuration processor 110 uses the output data 120 to partition the circuit design into multiple different contexts to be evaluated for possible local optimization. In some examples, the different contexts can correspond to different regions or logic groups of the identified in the logical and/or physical hierarchies of the circuit design represented in the output data 120.

As disclosed in further detail below, the localized context configuration processor 110 analyzes the synthesized circuit characteristics included in the output data 120 to identify one or more outlier contexts for which local optimization is to be configured. As disclosed in further detail below, the localized context configuration processor 110 determines respective local set(s) of configuration parameter for the one or more identified outlier contexts, and includes the local set(s) of configuration parameters in the configuration parameters 125 to be used by the EDA tool 105 to synthesize the input logical circuit design 115 in a subsequent execution iteration. However, unlike the initial execution iteration, in the subsequent execution iteration, the EDA tool 105 applies the local set(s) of configuration parameter to their respective identified outlier context(s) to perform local optimization of those identified outlier context(s), and applies the global set of configuration parameters to the other ones of the contexts not identified as outliers. As disclosed in further detail below, the localized context configuration processor 110 can continue to cause the EDA tool 105 to perform subsequent execution iterations on different outlier contexts and with different corresponding local parameter sets until a set of design goals and/or constraints is met, a maximum number of execution iterations has been met, etc. At that point, the localized context configuration processor 110 causes the output data 120 for that final execution iteration to be output as example final output data 130, which includes a final synthesized physical design (e.g., netlist) of the circuit and associated characteristics of the final synthesized circuit.

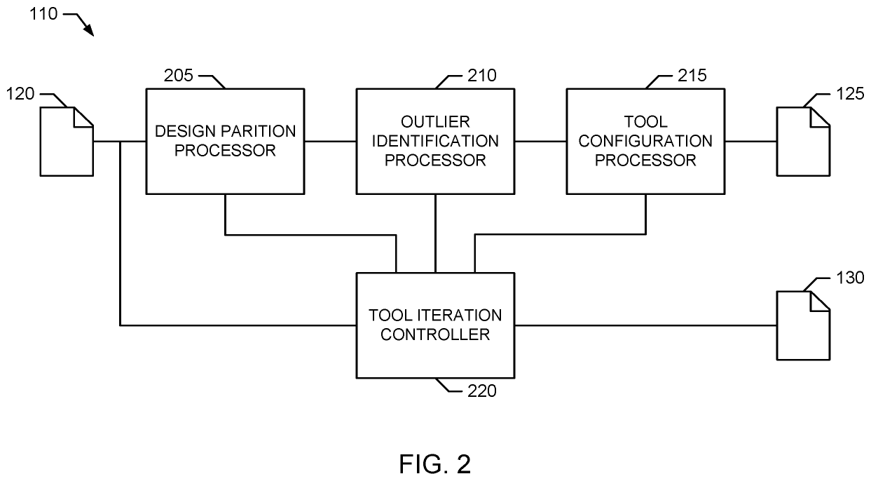

A block diagram of an example implementation of the localized context configuration processor 110 of FIG. 1 is illustrated in FIG. 2. The localized context configuration processor 110 of FIG. 2 may be instantiated (e.g., creating an instance of, bring into being for any length of time, materialize, implement, etc.) by processor circuitry such as a central processing unit executing instructions. Additionally or alternatively, the localized context configuration processor 110 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

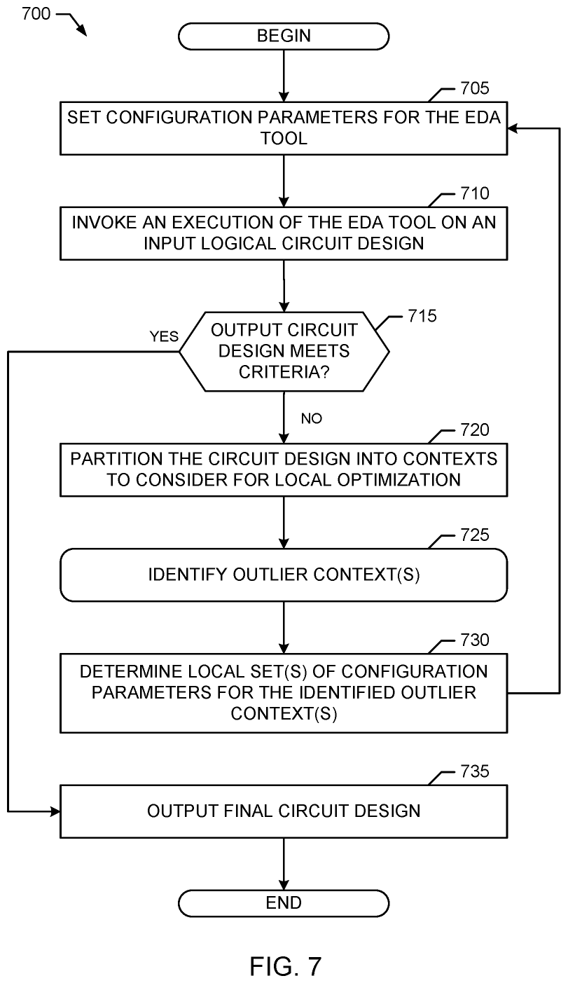

The illustrated example localized context configuration processor 110 of FIG. 2 incudes an example design partition processor 205, an example outlier identification processor 210, an example tool configuration processor 215, and an example tool iteration controller 220. In some examples, the design partition processor 205 is instantiated by processor circuitry executing design partition instructions and/or configured to perform operations such as those represented by the flowchart of FIG. 7. In some examples, the outlier identification processor 210 is instantiated by processor circuitry executing outlier identification instructions and/or configured to perform operations such as those represented by the flowcharts of FIGS. 7 and/or 8. In some examples, the tool configuration processor 215 is instantiated by processor circuitry executing tool configuration instructions and/or configured to perform operations such as those represented by the flowchart of FIG. 7. In some examples, the tool iteration controller 220 is instantiated by processor circuitry executing design partition instructions and/or configured to perform operations such as those represented by the flowchart of FIG. 7.

Turning to the illustrated example of FIG. 2, the design partition processor 205 of the localized context configuration processor 110 accesses the output data 120 from an execution iteration of the EDA tool 105 and partitions the output circuit design (e.g., as specified by a netlist included in the output data 120) into multiple contexts to be evaluated for possible local optimization treatment. For example, the contexts can correspond to different logic groups (e.g., groups of logical cells and/or logical gates) identified by the design partition processor 205 at one or more hierarchical levels of the physical circuit design represented in the output data 120. Additionally or alternatively, in some examples, the design partition processor 205 can determine the contexts based on logic cone targeted optimization, group level optimization, etc. Additionally or alternatively, in some examples, the design partition processor 205 accesses the input data 115 to partition the input logical circuit design (e.g., RTL) into multiple contexts corresponding to different logical functions implemented by the circuit.

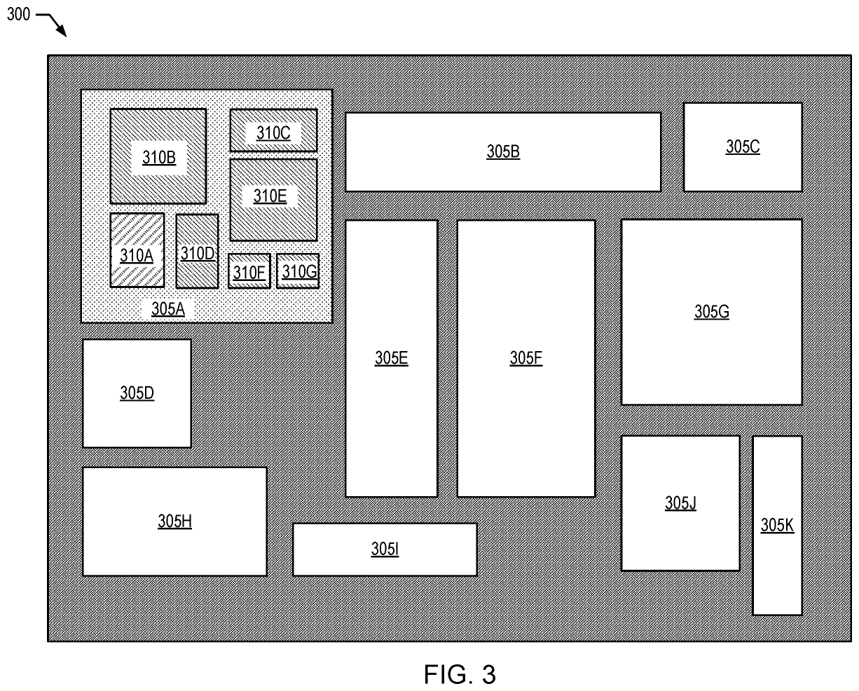

An example design partitioning operation performed by the design partition processor 205 of the localized context configuration processor 110 to produce an example design partition 300 is illustrated in FIG. 3. In the illustrated example of FIG. 3, the design partition processor 205 partitions the physical circuit design represented in the output data 120 (e.g., netlist) from the EDA tool 105 into a first set of example contexts 305A-K corresponding to different example logic groups (e.g., groups of logical cells and/or logical gates) at a first hierarchical level that is one level down from a top hierarchical level of the design. In the illustrated example, the design partition processor 205 also partitions the physical circuit design into a second set of example contexts 310A-G corresponding to different example logic groups (e.g., groups of logical cells and/or logical gates) at a second hierarchical level that is two levels down from the top hierarchical level of the design. In the illustrated example, to reduce unnecessary expenditure of processing resources and to improve execution time, the design partition processor 205 also limits the partitioning at the second hierarchical level to focus on just those partitioned contexts of the first hierarchical level that are identified as outliers, such as the example context 305A. For example, the example context 305A may be identified as an outlier context in the first hierarchical level of the design, and the example context 310A may be identified as an outlier context in the second hierarchical level of the design. In some examples, the design partition processor 205 can be configured (e.g., based on user input data) to partition the circuit design at the illustrated example hierarchical levels and/or other hierarchical levels and/or combinations of hierarchical levels using any appropriate partitioning technique or combination of techniques. In some such examples, the design partition processor 205 can be configured to partition the circuit design recursively at different hierarchical level(s) for different execution iterations of the EDA tool 105.

Returning to FIG. 2, the outlier identification processor 210 of the localized context configuration processor 110 performs an example design sensitivity analysis using one or more of the synthesized design characteristics included in the output data 120 to determine whether one or more of the partitioned circuit contexts identified by the design partition processor 205 exhibit different optimization bias relative to the majority of the contexts and, thus, are possible outlier contexts to be considered for localized optimization treatment. For example, utilizing a single set of global configuration parameters applied by the EDA tool 105 globally to the circuit design can result in one or more contexts exhibiting power over-budgeting issues and, thus, consuming substantially more power relative to their circuit area than the majority of the other contexts. In such examples, the design sensitivity analysis performed by the outlier identification processor 210 can identify such outlier contexts and modify one or more of the global set of configuration parameters to yield a local set of configurations parameters to be applied to that outlier context to perform localized optimization.

For example, the outlier identification processor 210 can be configured to analyze the synthesized design characteristics included in the output data 120 of the EDA tool 105 to determine one or more power characteristics, one or more area characteristics and/or one or more timing characteristics for respective ones of the partitioned circuit contexts identified by the design partition processor 205. In some examples, to determine the sensitivities of the different circuit contexts, the outlier identification processor 210 also normalizes the one or more power characteristics and/or the one or more timing characteristics for the respective ones of the partitioned circuit contexts by the one or more area characteristics for the respective ones of the partitioned circuit contexts to determine one or more normalized power characteristics and/or one or more normalized timing characteristics for the respective ones of the partitioned circuit contexts. In some examples, the outlier identification processor 210 the compares the one or more normalized power characteristics and/or the one or more normalized timing characteristics for the respective ones of the partitioned circuit contexts to one or more thresholds to identify one or more outlier contexts to be targeted for localized optimization.

In some examples, to determine the one or more thresholds for identifying outlier contexts, the outlier identification processor 210 analyzes at least a specified percentage of the contexts to identify threshold(s) that are exceeded by normalized power and/or timing characteristics for one or more specified fractions of the percentage of analyzed contexts. For example, the outlier identification processor 210 may analyze 20% or more of the contexts to identify a first threshold for which the normalized power and/or timing characteristics are exceeded by just one-tenth or 10% (or some other fraction) of those contexts, identify a second threshold for which the normalized power and/or timing characteristics are exceeded by just one-twentieth or 5% (or some other fraction) of those contexts, and/or identify a third threshold for which the normalized power and/or timing characteristics are exceeded by just one-hundredth or 1% (or some other fraction) of those contexts, etc. In some examples, the outlier identification processor 210 also adds a tolerance of 50% or some other value to the outlier thresholds determined by comparing the specified percentage of the contexts.

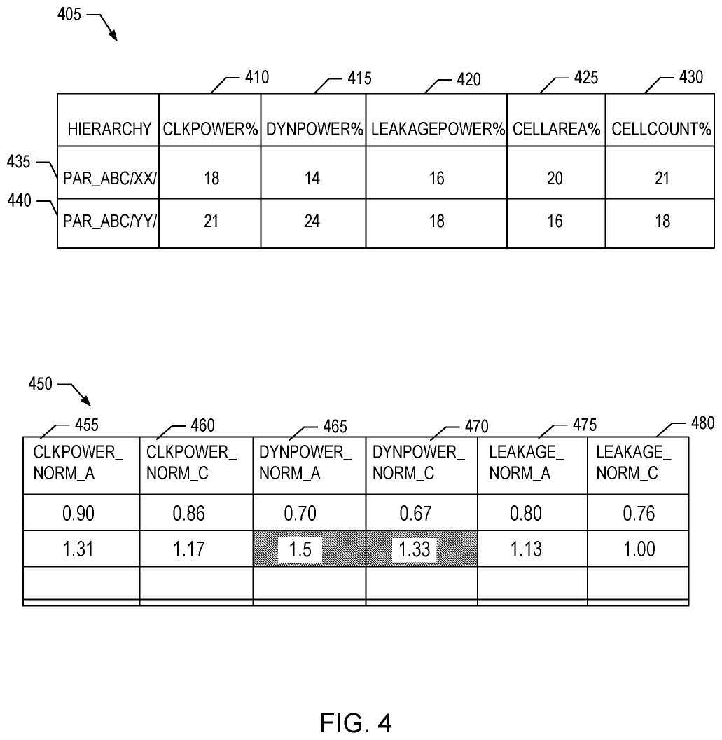

An example outlier identification operation performed by the outlier identification processor 210 of the localized context configuration processor 110 to identify outlier contexts in a partitioned circuit design is illustrated in FIG. 4. The illustrated example of FIG. 4 includes a first table 405 that illustrates example power characteristics 410-420 and example area characteristics 425-430 determined for first and second example circuit contexts 435 and 440 by the outlier identification processor 210 based on the output data 120 from the EDA tool 105. The first context 435 and the second context 440 in this example correspond to two different logic groups partitioned one hierarchical level down from a top level of the circuit design. In the illustrated example, the outlier identification processor 210 determines example clock power characteristics 410, example dynamic power characteristics 415 and example leakage power characteristics 420 for the first context 435 and the second context 440 based on the output data 120 from the EDA tool 105. The clock power characteristics 410, the dynamic power characteristics 415 and the leakage power characteristics 420 represent percentages of the overall circuit clock power, dynamic power and leakage power, respectively, attributed to the first context 435 and the second context 440, respectively. In the illustrated example, the outlier identification processor 210 also determines example cell area characteristics 425 and example cell count characteristics 430 for the first context 435 and the second context 440 based on the output data 120 from the EDA tool 105. The cell area characteristics 425 and cell count characteristics 430 represent percentages of the overall circuit cell area and cell count, respectively, attributed to the first context 435 and the second context 440, respectively.

The illustrated example of FIG. 4 also includes a second table 450 that illustrates example normalized power characteristics 455-480 determined for the first and second circuit contexts 435 and 440 by the outlier identification processor 210. In the illustrated example, the outlier identification processor 210 normalized the clock power characteristics 410 by the cell area characteristics 425 to determine example first normalized clock power characteristics for the first and second circuit contexts 435 and 440. In the illustrated example, the outlier identification processor 210 normalized the clock power characteristics 410 by the cell count characteristics 430 to determine example second normalized clock power characteristics 460 for the first and second circuit contexts 435 and 440. In the illustrated example, the outlier identification processor 210 normalized the dynamic power characteristics 415 by the cell area characteristics 425 to determine example first normalized dynamic power characteristics 465 for the first and second circuit contexts 435 and 440. In the illustrated example, the outlier identification processor 210 normalized the dynamic power characteristics 415 by the cell count characteristics 430 to determine example second dynamic power characteristics 470 for the first and second circuit contexts 435 and 440. In the illustrated example, the outlier identification processor 210 normalized the leakage power characteristics 420 by the cell area characteristics 425 to determine example first normalized leakage power characteristics 475 for the first and second circuit contexts 435 and 440. In the illustrated example, the outlier identification processor 210 normalized the leakage power characteristics 420 by the cell count characteristics 430 to determine example second leakage power characteristics 480 for the first and second circuit contexts 435 and 440.

As explained above, the outlier identification processor 210 then compares the normalized power characteristics 455-480 determined for the first and second circuit contexts 435 and 440 to one or more thresholds to identify whether one or more of the contexts 435 and 440 are outlier contexts to be considered for localized optimization. In some examples, the outlier identification processor 210 utilizes a threshold of one (1) and identifies outlier contexts for which their normalized characteristics exceed that threshold. In the illustrated example, the outlier identification processor 210 utilizes a threshold of 1.32 to identify outlier contexts. Thus, in the illustrated example, the outlier identification processor 210 determines that the second context 440 has dynamic power characteristics 465 and 470 that exceed the threshold and, thus, identifies the second circuit context 440 as an outlier context for localized dynamic power optimization.

In some examples, the outlier identification processor 210 utilizes multiple thresholds to define different severity ranges for outlier contexts. For example, the outlier identification processor 210 can define a first (e.g., minor) severity range for outlier contexts having normalized characteristics between threshold values of 1.5 and 3 (or some other threshold values). In some such examples, the outlier identification processor 210 can define a second (e.g., intermediate) severity range for outlier contexts having normalized characteristics between threshold values of 3 and 5 (or some other threshold values). In some such examples, the outlier identification processor 210 can define a third (e.g., severe) severity range for outlier contexts having normalized characteristics that exceed a threshold value of 5 (or some other threshold value). In some examples, the outlier identification processor 210 can be configured with additional or fewer thresholds to define additional or fewer severity ranges for outlier contexts.

Returning to FIG. 2, the tool configuration processor 215 of the localized context configuration processor 110 determines local set(s) of configuration parameters for the outlier context(s) identified by the outlier identification processor 210 and associates (e.g., with identification information) the local set(s) of configuration parameters with their respective outlier context(s). The tool configuration processor 215 then includes the local set(s) of configuration parameters in the configuration parameters 125 to be used by the EDA tool 105 to synthesize the input logical circuit design 115 in a subsequent execution iteration. In some examples, the tool configuration processor 215 varies one or more of the parameters included in the global set of configuration parameters to determine the local set of configuration parameters for a specific outlier context. For example, the tool configuration processor 215 may select the parameter(s) to be varied based on the particular normalized characteristic(s) that caused the outlier context to be identified as an outlier.

For example, if an outlier context was identified based on a normalized clock power characteristic exceeding a threshold, the tool configuration processor 215 may vary the global configuration parameter(s) associated with clock power to determine the local set of configuration parameters for that context. Similarly, if an outlier context was identified based on a normalized dynamic power characteristic exceeding a threshold, the tool configuration processor 215 may vary the global configuration parameter(s) associated with dynamic power to determine the local set of configuration parameters for that context. Likewise, if an outlier context was identified based on a normalized leakage power characteristic exceeding a threshold, the tool configuration processor 215 may vary the global configuration parameter(s) associated with leakage power to determine the local set of configuration parameters for that context. Other example context-based recipes for varying configuration parameters to create a local set for a particular outlier context include re-balancing relative contributions of different threshold voltage devices, masking specific drive strength cells to be used or not used in favor of timing, power and/or routing congestion issues, setting tool specific margin threshold for setup and hold timings, setting tool specific relative optimization efforts or iteration pass limits, etc.

In some examples, the tool configuration processor 215 determines histograms of node-slack and/or path-slack characteristics included in the output data 120 for the different partitioned contexts to determine modified slack thresholds (also referred to as slack bias points) to be included in the local set(s) of configuration parameters for the identified outlier contexts. Slack refers to the amount a timing characteristic in an output circuit design from the EDA tool 105 deviates from (e.g., exceeds or falls below) a target timing threshold. Such timing thresholds can correspond to circuit paths or circuit nodes (e.g., logic cells) and, thus, the slack characteristics can include path-slack values and node-slack values for the different partitioned contexts identified in the circuit design. Thus, positive slack values generally correspond to portions of the circuit design that surpass a timing target, and negative slack values generally correspond to portions of the circuit design that fall short of the timing target.

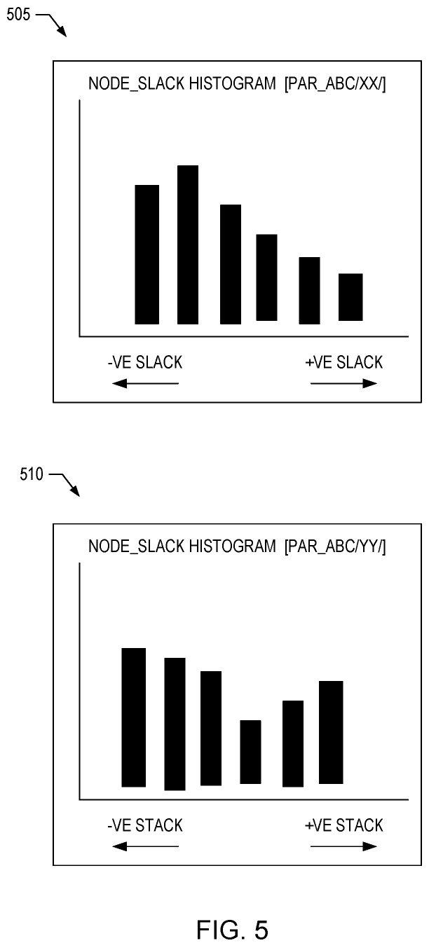

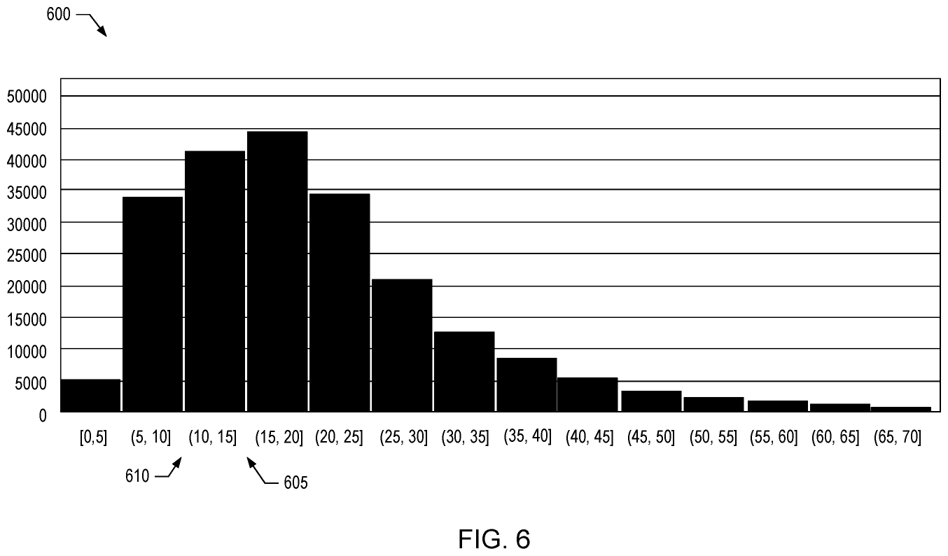

FIGS. 5-6 illustrate example slack histograms generated by the tool configuration processor 215. In particular, FIG. 5 illustrates a first example slack histogram 505 determined by the tool configuration processor 215 for the first example circuit context 435 described above in association with the example of FIG. 4. FIG. 5 also illustrates a second example slack histogram 510 determined by the tool configuration processor 215 for the second example circuit context 440 described above in association with the example of FIG. 4. Thus, the example of FIG. 5 illustrates that the tool configuration processor 215 can determine different slack histograms for different ones of the partitioned contexts identified in the circuit design.

FIG. 6 illustrates a more detailed example slack histogram 605 that can be used to illustrate example operations performed by the tool configuration processor 215 to vary the slack threshold parameter (or slack bias point) for a particular outlier context. For example, assume that the slack threshold in the global set of configuration parameters is set to 15, which corresponds to reference numeral 605 in FIG. 6. If a particular outlier context is associated with a normalized power characteristics that exceeds an outlier threshold, the tool configuration processor 215 may reduce the slack threshold in the local set of configuration parameters for that outlier context to 10, which corresponds to reference numeral 610 in FIG. 6. By reducing the slack threshold for that particular outlier context, the EDA tool 105 will be biased to locally balance power vs. timing optimization trade-off for that particular outlier context.

In some examples, the tool configuration processor 215 can specify a transition region in the local set of parameters for a particular outlier context. For example, the transition may specify a path width, a number of logic cells/gates, a border (e.g., in microns), etc., between the particular outlier context and other contexts partitioned from the circuit design. In some such examples, the transition region specified in a local parameter set for an outlier context causes the EDA tool 105 to apply the local set of parameters to the outlier context and the global set of parameters to other contexts outside the transition region. But, within the transition region, the EDA tool 105 applies an intermediate set of parameters based on the global set of parameters and the local set of parameters. For example, the EDA tool 105 may average respective parameters in the global and local parameter sets to determine the intermediate set of parameters to apply in the transition region.

In some examples, the tool configuration processor 215 specifies (e.g., via the input configuration parameters 125) which, if any, of the outlier contexts identified in the circuit design can be optimized by the EDA tool 105 in parallel. For example, the tool configuration processor 215 may analyze the input logical circuit design 115 and/or the output physical circuit design in the output data 120 to determine whether the two or more outlier contexts in the circuit satisfy one or more criteria to permit parallel optimization to be performed. Examples include simultaneous optimization of clock power and leakage power on non-overlapping contexts, optimization of a subset of timing and power, optimization of a subset of timing and routing congestion, etc.

Returning to FIG. 2, the tool iteration controller 220 of the localized context configuration processor 110 invokes the EDA tool 105 to perform multiple (e.g., recursive) execution iterations on different outlier contexts and with different corresponding local parameter sets. The tool iteration controller 220 of the illustrated example continues to invoke successive execution iterations of the EDA tool 105 until one or more design goals and/or constraints, such as one or more PPA goals are met, a maximum number of execution iterations has been met, etc. At that point, the tool iteration controller 220 causes the output data 120 for that final execution iteration to be output as example final output data 130, which includes a final synthesized physical design (e.g., netlist) of the circuit and associated characteristics of the final synthesized circuit.

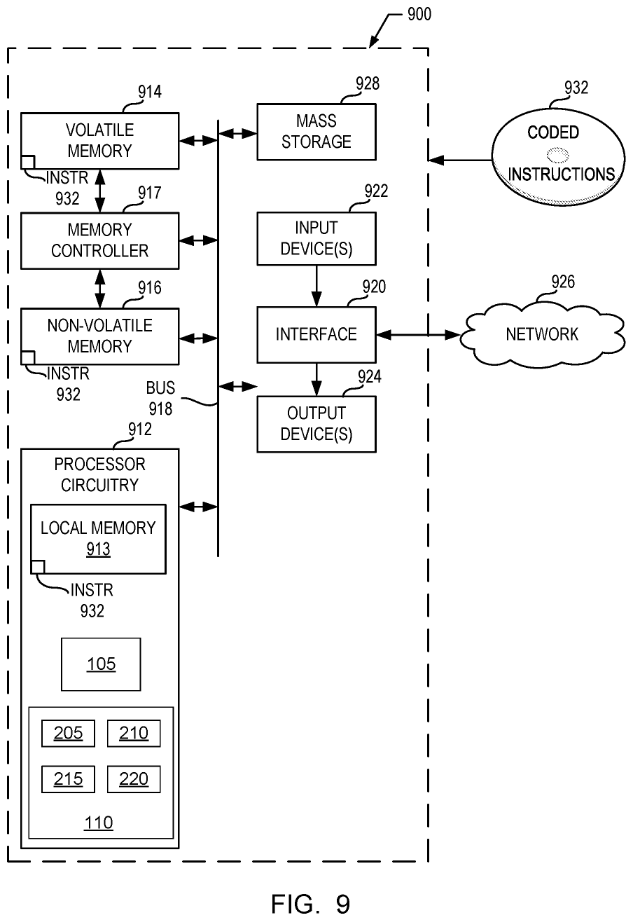

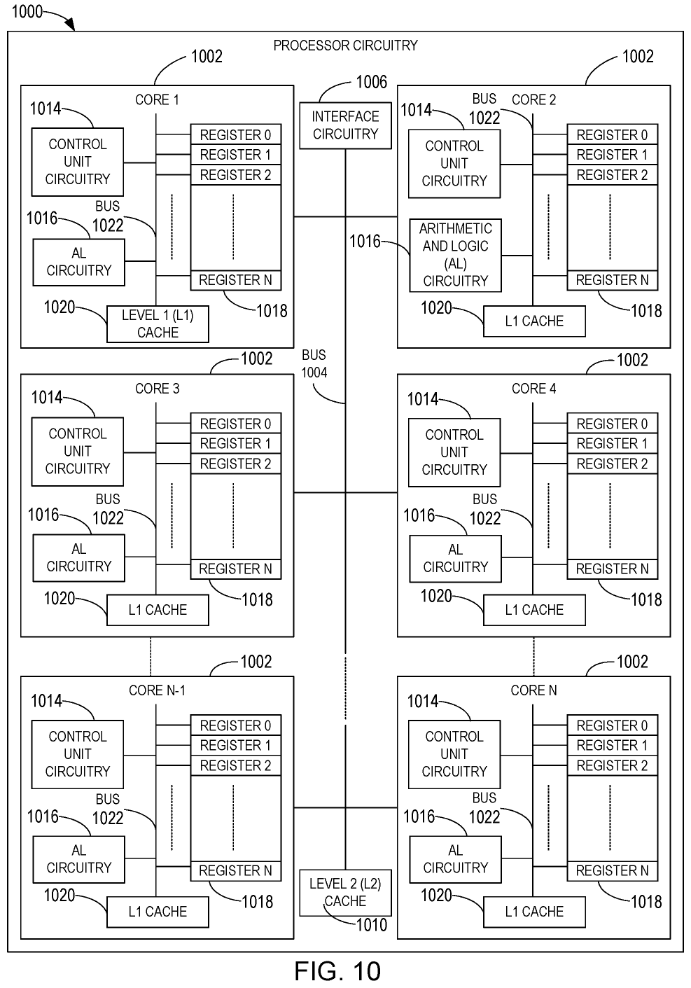

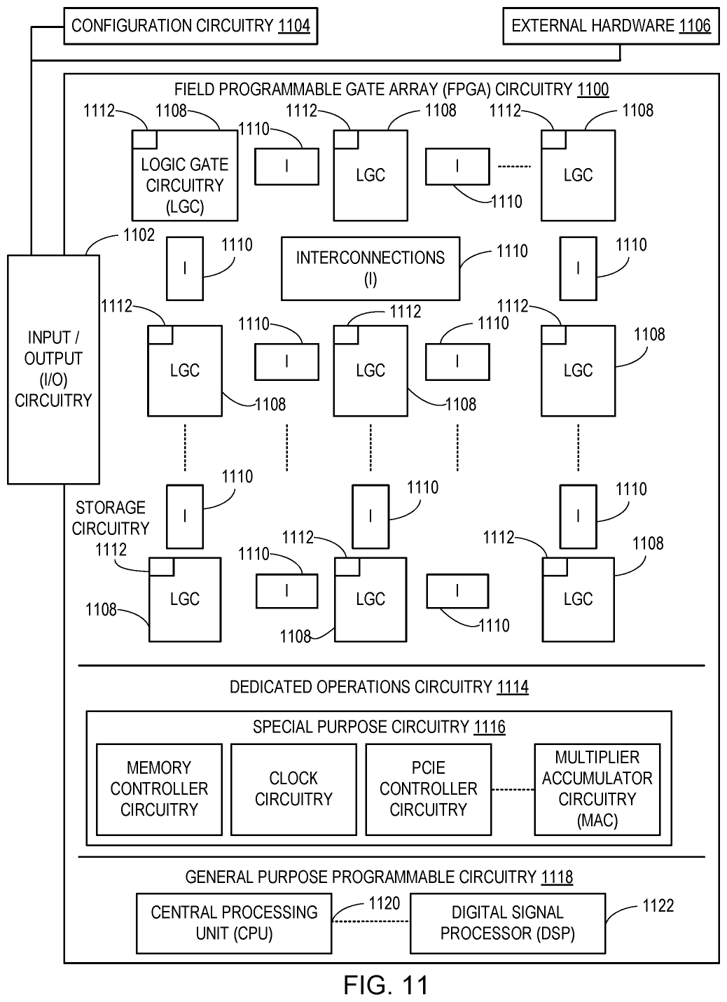

In some examples, the localized context configuration processor 110 includes means for partitioning a circuit design into contexts. For example, the means for partitioning may be implemented by design partition processor 205. In some examples, the design partition processor 205 may be instantiated by processor circuitry such as the example processor circuitry 912 of FIG. 9. For instance, the design partition processor 205 may be instantiated by the example microprocessor 1000 of FIG. 10 executing machine executable instructions such as those implemented by at least blocks 720 of FIG. 7. In some examples, the design partition processor 205 may be instantiated by hardware logic circuitry, which may be implemented by an ASIC, XPU, or the FPGA circuitry 1100 of FIG. 11 structured to perform operations corresponding to the machine readable instructions. Additionally or alternatively, the design partition processor 205 may be instantiated by any other combination of hardware, software, and/or firmware. For example, the design partition processor 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

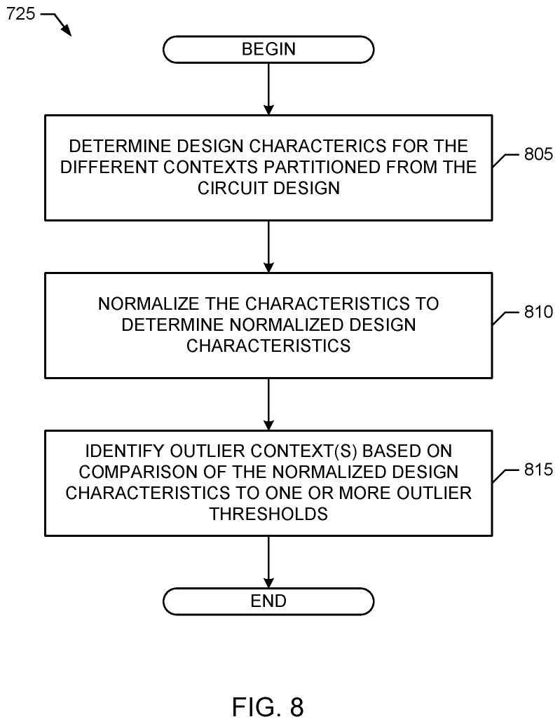

In some examples, the localized context configuration processor 110 includes means for identifying outlier contexts. For example, the means for identifying outlier contexts may be implemented by the outlier identification processor 210. In some examples, the outlier identification processor 210 may be instantiated by processor circuitry such as the example processor circuitry 912 of FIG. 9. For instance, the design partition processor 205 may be instantiated by the example microprocessor 1000 of FIG. 10 executing machine executable instructions such as those implemented by at least blocks 725 of FIG. 7 and blocks 805-815 of FIG. 8. In some examples, the outlier identification processor 210 may be instantiated by hardware logic circuitry, which may be implemented by an ASIC, XPU, or the FPGA circuitry 1100 of FIG. 11 structured to perform operations corresponding to the machine readable instructions. Additionally or alternatively, the outlier identification processor 210 may be instantiated by any other combination of hardware, software, and/or firmware. For example, the outlier identification processor 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the localized context configuration processor 110 includes means for configuring EDA tool parameters. For example, the means for configuring may be implemented by tool configuration processor 215. In some examples, the tool configuration processor 215 may be instantiated by processor circuitry such as the example processor circuitry 912 of FIG. 9. For instance, the tool configuration processor 215 may be instantiated by the example microprocessor 1000 of FIG. 10 executing machine executable instructions such as those implemented by at least blocks 730 of FIG. 7. In some examples, the tool configuration processor 215 may be instantiated by hardware logic circuitry, which may be implemented by an ASIC, XPU, or the FPGA circuitry 1100 of FIG. 11 structured to perform operations corresponding to the machine readable instructions. Additionally or alternatively, the tool configuration processor 215 may be instantiated by any other combination of hardware, software, and/or firmware. For example, the tool configuration processor 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the localized context configuration processor 110 includes means for controlling execution iterations of an EDA tool. For example, the means for controlling may be implemented by the tool iteration controller 220. In some examples, the tool iteration controller 220 may be instantiated by processor circuitry such as the example processor circuitry 912 of FIG. 9. For instance, the tool iteration controller 220 may be instantiated by the example microprocessor 1000 of FIG. 10 executing machine executable instructions such as those implemented by at least blocks 735 of FIG. 7. In some examples, the tool iteration controller 220 may be instantiated by hardware logic circuitry, which may be implemented by an ASIC, XPU, or the FPGA circuitry 1100 of FIG. 11 structured to perform operations corresponding to the machine readable instructions. Additionally or alternatively, the tool iteration controller 220 may be instantiated by any other combination of hardware, software, and/or firmware. For example, the tool configuration processor 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While example manners of implementing the example EDA tool 105 and the example localized context configuration processor 110 are illustrated in FIGS. 1-6, one or more of the elements, processes, and/or devices illustrated in FIGS. 1-6 may be combined, divided, re-arranged, omitted, eliminated, and/or implemented in any other way. Further, the example design partition processor 205, the example outlier identification processor 210, the example tool configuration processor 215, the example tool iteration controller 220 and/or, more generally, the example EDA tool 105 and/or the example localized context configuration processor 110 of FIGS. 1-6, may be implemented by hardware alone or by hardware in combination with software and/or firmware. Thus, for example, any of the example design partition processor 205, the example outlier identification processor 210, the example tool configuration processor 215, the example tool iteration controller 220 and/or, more generally, the example EDA tool 105 and/or the example localized context configuration processor 110 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example EDA tool 105 and/or the example localized context configuration processor 110 may include one or more elements, processes, and/or devices in addition to, or instead of, those illustrated in FIGS. 1-6, and/or may include more than one of any or all of the illustrated elements, processes and devices.

Flowcharts representative of example machine readable instructions, which may be executed to configure processor circuitry to implement the example EDA tool 105 and/or the example localized context configuration processor 110 of FIGS. 1-6, are shown in FIGS. 7-8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program(s) or portions thereof may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowcharts illustrated in FIGS. 7-8, many other methods of implementing the example EDA tool 105 and/or the example localized context configuration processor 110 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 7-8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc. Also, as used herein, the terms “computer readable” and “machine readable” are considered equivalent unless indicated otherwise.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to implement the example localized context configuration processor 110. With reference to the preceding figures and associated written descriptions, the machine readable instructions and/or the operations 700 of FIG. 7 begin at block 705, at which the tool configuration processor 215 of the localized context configuration processor 110 sets the configuration parameters 125 of the EDA tool 105. As disclosed above, at block 705, the tool configuration processor 215 sets the configuration parameters 125 to include a global set of configuration parameters for an initial execution iteration of the EDA tool 105. For subsequent execution iterations of the EDA tool 105, the tool configuration processor 215 sets the configuration parameters 125 to include local set(s) of configuration parameters for respective outlier context(s) identified in the circuit design, but retains the global set of configuration parameters in the configuration parameters 125 to be applied to other contexts not identified as outliers.

At block 710, the tool iteration controller 220 of the localized context configuration processor 110 invokes the EDA tool 105 to perform an execution iteration on the input logical circuit design 115 to produce the output data 120 corresponding to the synthesized physical circuit design, as described above. At block 715, the tool iteration controller 220 determined whether one or more design criteria are met by the output physical circuit design. As described above, such design criteria can be one or more design goals/constraints, a maximum number of execution iterations, etc.

If the design criteria are not met (e.g., the NO branch out of block 715), at block 720 the design partition processor 205 of the localized context configuration processor 110 partitions the circuit design into multiple contexts to be considered for local optimization treatment, as described above. At block 725, the outlier identification processor 210 of the localized context configuration processor 110 identifies, as described above, outlier context(s) from the circuit contexts identified at block 720. Example machine readable instructions and/or example operations that may be executed and/or instantiated by processor circuitry to implement the processing at block 725 are illustrated in FIG. 8, which is described in further detail below. At block 730, the tool configuration processor 215 determines local set(s) of configuration parameters for the outlier contexts(s) identified at block 725. Processing then returns to block 705 and blocks subsequent thereto.

However, if the design criteria are met (e.g., the YES branch out of block 715), at block 735 the tool iteration controller 220 outputs the final output data 130, which includes the final synthesized physical design (e.g., netlist) of the circuit and associated characteristics of the final synthesized circuit, as described above. The machine readable instructions and/or the operations 700 then end.

FIG. 8 is a flowchart representative of example machine readable instructions and/or example operations 725 that may be executed and/or instantiated by processor circuitry to implement the processing at block 725 of FIG. 7. With reference to the preceding figures and associated written descriptions, the machine readable instructions and/or the operations 725 of FIG. 8 begin at block 805 at which the outlier identification processor 210 of the localized context configuration processor 110 analyzes the output data 120 from the execution iteration of the EDA tool 105 to determine design characteristics (e.g., power characteristics, timing characteristics, area characteristics, etc.) for the different contexts partitioned from the circuit design, as described above. At block 810, the outlier identification processor 210 normalizes the design characteristics to determine normalized design characteristics for the different circuit contexts, as described above. At block 815, the outlier identification processor 210 compares the normalized design characteristics to one or more outlier thresholds to identify outlier context(s) for which localized optimization is to be configured. The machine readable instructions and/or the operations 725 then end.

FIG. 9 is a block diagram of an example processor platform 900 structured to execute and/or instantiate the machine readable instructions and/or the operations of FIGS. 7-8 to implement the example EDA tool 105 and the example localized context configuration processor 110 of FIGS. 1-6. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the example design partition processor 205, the example outlier identification processor 210, the example tool configuration processor 215, the example tool iteration controller 220 and/or, more generally, the example EDA tool 105 and/or the example localized context configuration processor 110.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 922 are arranged or otherwise configured to allow the user to control the processor platform 900 and provide data to the processor platform 900 using physical gestures, such as, but not limited to, hand or body movements, facial expressions, face recognition, etc.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 932, which may be implemented by the machine readable instructions of FIGS. 7-8, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIG. 7-8 to effectively instantiate the circuitry of FIG. 2 as logic circuits to perform the operations corresponding to those machine readable instructions. In some such examples, the example EDA tool 105 and the example localized context configuration processor 110 of FIGS. 1-6 is instantiated by the hardware circuits of the microprocessor 1000 in combination with the instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowchart of FIG. _.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 7-8 but whose interconnections and logic circuitry are fixed once fabricated), the FPGA circuitry 1100 of the example of FIG. 11s includes interconnections and logic circuitry that may be configured and/or interconnected in different ways after fabrication to instantiate, for example, some or all of the machine readable instructions represented by the flowchart of FIGS. 7-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 7-8. As such, the FPGA circuitry 1100 may be structured to effectively instantiate some or all of the machine readable instructions of the flowcharts of FIGS. 7-8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 7-8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may be implemented by external hardware circuitry. For example, the external hardware 1106 may be implemented by the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations that may correspond to at least some of the machine readable instructions of FIGS. 8-9 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 7-8 may be executed by one or more of the cores 1002 of FIG. 10, a second portion of the machine readable instructions represented by the flowcharts of FIG. 7-8 may be executed by the FPGA circuitry 1100 of FIG. 11, and/or a third portion of the machine readable instructions represented by the flowcharts of FIGS. 7-8 may be executed by an ASIC. It should be understood that some or all of the circuitry of FIGS. 1-6 may, thus, be instantiated at the same or different times. Some or all of the circuitry may be instantiated, for example, in one or more threads executing concurrently and/or in series. Moreover, in some examples, some or all of the circuitry of FIGS. 1-6 may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

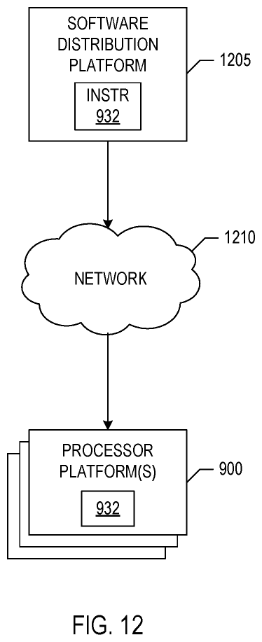

A block diagram illustrating an example software distribution platform 1205 to distribute software such as the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 7-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 7-8, may be downloaded to the example processor platform 900, which is to execute the machine readable instructions 932 to implement the example EDA tool 105 and the example localized context configuration processor 110. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that implement localized context configuration for electronic design automation. Disclosed systems, methods, apparatus, and articles of manufacture improve the efficiency of using a computing device by reduce circuit synthesis execution time by focusing localized circuit optimization on outlier circuit contexts and performing globalized circuit optimization on other circuit contexts not identified as outliers. Disclosed systems, methods, apparatus, and articles of manufacture are accordingly directed to one or more improvement(s) in the operation of a machine such as a computer or other electronic and/or mechanical device.

Further examples and combinations thereof disclosed herein include the following:

Example 1 includes at least one non-transitory computer readable medium comprising computer readable instructions to cause processor circuitry to at least partition a circuit design into a plurality of contexts based on output data from a first execution iteration of an electronic design automation (EDA) tool, the output data including a netlist representative of the circuit design, the output data based on a first set of configuration parameters applied globally to the circuit design by the EDA tool, identify an outlier context in the plurality of contexts based on the output data, and provide the EDA tool with a second set of configuration parameters to be applied locally to the outlier context in a second execution iteration of the EDA tool, the EDA tool to apply the first set of configuration parameters to other ones of the contexts not identified as outliers.

Example 2 includes the at least one non-transitory computer readable medium of example 1, wherein the contexts correspond to groups of logic cells partitioned at a hierarchical level of the circuit design.

Example 3 includes the at least one non-transitory computer readable medium of example 1 or example 2, wherein the outlier context is identified based on at least one of power characteristics, area characteristics or timing characteristics determined for respective ones of the contexts from the output data.

Example 4 includes the at least one non-transitory computer readable medium of any of examples 1 to 3, wherein the instructions are to cause the processor circuitry to determine, based on the output data, corresponding power characteristics and corresponding area characteristic for respective ones of the contexts, normalize the corresponding power characteristics by the corresponding area characteristics to determine normalized power characteristics for the respective ones of the contexts, and compare the normalized power characteristics to a threshold to identify the outlier context.

Example 5 includes the at least one non-transitory computer readable medium of any of examples 1 to 4, wherein the first set of parameters includes a first value for a slack threshold and the second set of parameters includes a second value for the slack threshold, the second value different from the first value.

Example 6 includes the at least one non-transitory computer readable medium of any of examples 1 to 5, wherein the instructions are to cause the processor circuitry to determine a histogram of slack values for the plurality of contexts based on the output data, and determine the second value of the slack threshold based on the histogram.

Example 7 includes the at least one non-transitory computer readable medium of any of examples 1 to 6, wherein the second set of parameters is to specify a transition region between the outlier context and the other ones of the contexts, the EDA tool is to apply the second set of parameters to the outlier context, the EDA tool is to apply the first set of parameters outside the transition region, and the EDA tool is to apply a third set of parameters in the transition region, the third set of parameters based on the first set of parameters and the second set of parameters.

Example 8 includes the at least one non-transitory computer readable medium of any of examples 1 to 7, wherein the circuit design corresponds to a system on a chip.

Example 9 includes an apparatus to operate an electronic design automation (EDA) tool, the apparatus comprising at least one memory, machine readable instructions, and processor circuitry to at least one of instantiate or execute the machine readable instructions to partition a circuit design into a plurality of contexts based on output data from a first execution iteration of the EDA tool, the output data including a netlist representative of the circuit design, the output data based on a first set of configuration parameters applied to the circuit design by the EDA tool, and provide the EDA tool with a second set of configuration parameters to be applied to an outlier context in a second execution iteration of the EDA tool, the EDA tool to apply the first set of configuration parameters to other ones of the contexts not identified as outliers.

Example 10 includes the apparatus of example 9, wherein the contexts correspond to groups of logic cells partitioned at a hierarchical level of the circuit design.

Example 11 includes the apparatus of example 9 or example 10, wherein the processor circuitry is to identify the outlier context based on at least one of power characteristics, area characteristics or timing characteristics determined for respective ones of the contexts from the output data.

Example 12 includes the apparatus of any of examples 9 to 11, wherein the instructions are to cause the processor circuitry to determine, based on the output data, corresponding power characteristics and corresponding area characteristic for respective ones of the contexts, normalize the corresponding power characteristics by the corresponding area characteristics to determine normalized power characteristics for the respective ones of the contexts, and compare the normalized power characteristics to a threshold to identify the outlier context.

Example 13 includes the apparatus of any of examples 9 to 12, wherein the first set of parameters includes a first value for a slack threshold and the second set of parameters includes a second value for the slack threshold, the second value different from the first value.

Example 14 includes the apparatus of any of examples 9 to 13, wherein the processor circuitry is to determine a histogram of slack values for the plurality of contexts based on the output data, and determine the second value of the slack threshold based on the histogram.

Example 15 includes the apparatus of any of examples 9 to 14, wherein the second set of parameters is to specify a transition region between the outlier context and the other ones of the contexts, the EDA tool is to apply the second set of parameters to the outlier context, the EDA tool is to apply the first set of parameters outside the transition region, and the EDA tool is to apply a third set of parameters in the transition region, the third set of parameters based on the first set of parameters and the second set of parameters.

Example 16 includes the apparatus of any of examples 9 to 15, wherein the circuit design corresponds to a system on a chip.

Example 17 includes a method to operate an electronic design automation (EDA) tool, the method comprising partitioning, by executing an instruction with processor circuitry, a circuit design into a plurality of contexts based on output data from a first execution iteration of the EDA tool, the output data including a netlist representative of the circuit design, the output data based on a first set of configuration parameters applied globally to the circuit design by the EDA tool identifying, by executing an instruction with the processor circuitry, at least one outlier context in the plurality of contexts based on the output data, and providing, by executing an instruction with the processor circuitry, the EDA tool with a second set of configuration parameters to be applied locally to the at least one outlier context in a second execution iteration of the EDA tool, the EDA tool to apply the first set of configuration parameters to other ones of the contexts not identified as outliers.

Example 18 includes the method of example 17, wherein the contexts correspond to groups of logic cells partitioned at a hierarchical level of the circuit design.

Example 19 includes the method of example 17 or example 18, wherein the identifying of the at least one outlier context is based on at least one of power characteristics, area characteristics or timing characteristics determined for respective ones of the contexts from the output data.

Example 20 includes the method of any of examples 17 to 19, wherein the identifying of the at least one outlier context includes determining, based on the output data, corresponding power characteristics and corresponding area characteristic for respective ones of the contexts, normalizing the corresponding power characteristics by the corresponding area characteristics to determine normalized power characteristics for the respective ones of the contexts, and comparing the normalized power characteristics to one or more thresholds to identify the at least one outlier context.

Example 21 includes the method of any of examples 17 to 20, wherein the first set of parameters includes a first value for a slack threshold and the second set of parameters includes a second value for the slack threshold, the second value different from the first value.

Example 22 includes the method of any of examples 17 to 21, further including determining a histogram of slack values for the plurality of contexts based on the output data, and determining the second value of the slack threshold based on the histogram.

Example 23 includes the method of any of examples 17 to 22, wherein the second set of parameters is to specify a transition region between the at least one outlier context and the other ones of the contexts, the EDA tool is to apply the second set of parameters to the at least one outlier context, the EDA tool is to apply the first set of parameters outside the transition region, and the EDA tool is to apply a third set of parameters in the transition region, the third set of parameters based on the first set of parameters and the second set of parameters.

Example 24 includes the method of any of examples 17 to 23, wherein the circuit design corresponds to a system on a chip.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. At least one non-transitory computer readable medium comprising computer readable instructions to cause processor circuitry to at least:
partition a circuit design into a plurality of contexts based on output data from a first execution iteration of an electronic design automation (EDA) tool, the output data including a netlist representative of the circuit design, the output data based on a first set of configuration parameters applied globally to the circuit design by the EDA tool;
identify an outlier context in the plurality of contexts based on the output data; and
provide the EDA tool with a second set of configuration parameters to be applied locally to the outlier context in a second execution iteration of the EDA tool, the EDA tool to apply the first set of configuration parameters to other ones of the contexts not identified as outliers.

2. The at least one non-transitory computer readable medium of claim 1, wherein the contexts correspond to groups of logic cells partitioned at a hierarchical level of the circuit design.

3. The at least one non-transitory computer readable medium of claim 1, wherein the outlier context is identified based on at least one of power characteristics, area characteristics or timing characteristics determined for respective ones of the contexts from the output data.

4. The at least one non-transitory computer readable medium of claim 1, wherein the instructions are to cause the processor circuitry to:
determine, based on the output data, corresponding power characteristics and corresponding area characteristic for respective ones of the contexts;
normalize the corresponding power characteristics by the corresponding area characteristics to determine normalized power characteristics for the respective ones of the contexts; and
compare the normalized power characteristics to a threshold to identify the outlier context.

5. The at least one non-transitory computer readable medium of claim 1, wherein the first set of parameters includes a first value for a slack threshold and the second set of parameters includes a second value for the slack threshold, the second value different from the first value.

6. The at least one non-transitory computer readable medium of claim 5, wherein the instructions are to cause the processor circuitry to:
determine a histogram of slack values for the plurality of contexts based on the output data; and
determine the second value of the slack threshold based on the histogram.

7. The at least one non-transitory computer readable medium of claim 1, wherein the second set of parameters is to specify a transition region between the outlier context and the other ones of the contexts, the EDA tool is to apply the second set of parameters to the outlier context, the EDA tool is to apply the first set of parameters outside the transition region, and the EDA tool is to apply a third set of parameters in the transition region, the third set of parameters based on the first set of parameters and the second set of parameters.

8. The at least one non-transitory computer readable medium of claim 1, wherein the circuit design corresponds to a system on a chip.

9. An apparatus to operate an electronic design automation (EDA) tool, the apparatus comprising:
at least one memory;
machine readable instructions; and
processor circuitry to at least one of instantiate or execute the machine readable instructions to:
partition a circuit design into a plurality of contexts based on output data from a first execution iteration of the EDA tool, the output data including a netlist representative of the circuit design, the output data based on a first set of configuration parameters applied to the circuit design by the EDA tool; and
provide the EDA tool with a second set of configuration parameters to be applied to an outlier context in a second execution iteration of the EDA tool, the EDA tool to apply the first set of configuration parameters to other ones of the contexts not identified as outliers.

10. The apparatus of claim 9, wherein the contexts correspond to groups of logic cells partitioned at a hierarchical level of the circuit design.

11. The apparatus of claim 9, wherein the processor circuitry is to identify the outlier context based on at least one of power characteristics, area characteristics or timing characteristics determined for respective ones of the contexts from the output data.

12. The apparatus of claim 9, wherein the instructions are to cause the processor circuitry to:
determine, based on the output data, corresponding power characteristics and corresponding area characteristic for respective ones of the contexts;
normalize the corresponding power characteristics by the corresponding area characteristics to determine normalized power characteristics for the respective ones of the contexts; and
compare the normalized power characteristics to a threshold to identify the outlier context.

13. The apparatus of claim 9, wherein the first set of parameters includes a first value for a slack threshold and the second set of parameters includes a second value for the slack threshold, the second value different from the first value.

14. The apparatus of claim 13, wherein the processor circuitry is to:
determine a histogram of slack values for the plurality of contexts based on the output data; and
determine the second value of the slack threshold based on the histogram.

15. The apparatus of claim 9, wherein the second set of parameters is to specify a transition region between the outlier context and the other ones of the contexts, the EDA tool is to apply the second set of parameters to the outlier context, the EDA tool is to apply the first set of parameters outside the transition region, and the EDA tool is to apply a third set of parameters in the transition region, the third set of parameters based on the first set of parameters and the second set of parameters.

16. The apparatus of claim 9, wherein the circuit design corresponds to a system on a chip.

17. A method to operate an electronic design automation (EDA) tool, the method comprising:
partitioning, by executing an instruction with processor circuitry, a circuit design into a plurality of contexts based on output data from a first execution iteration of the EDA tool, the output data including a netlist representative of the circuit design, the output data based on a first set of configuration parameters applied globally to the circuit design by the EDA tool
identifying, by executing an instruction with the processor circuitry, at least one outlier context in the plurality of contexts based on the output data; and
providing, by executing an instruction with the processor circuitry, the EDA tool with a second set of configuration parameters to be applied locally to the at least one outlier context in a second execution iteration of the EDA tool, the EDA tool to apply the first set of configuration parameters to other ones of the contexts not identified as outliers.

18. The method of claim 17, wherein the contexts correspond to groups of logic cells partitioned at a hierarchical level of the circuit design.

19. The method of claim 17, wherein the identifying of the at least one outlier context is based on at least one of power characteristics, area characteristics or timing characteristics determined for respective ones of the contexts from the output data.

20. The method of claim 17, wherein the identifying of the at least one outlier context includes:
determining, based on the output data, corresponding power characteristics and corresponding area characteristic for respective ones of the contexts;
normalizing the corresponding power characteristics by the corresponding area characteristics to determine normalized power characteristics for the respective ones of the contexts; and
comparing the normalized power characteristics to one or more thresholds to identify the at least one outlier context.

21-24. (canceled)
